(19) United States
(12) Patent Application Publication
(10) Pub. No.: US 2016/0114259 A1
(43) Pub. Date: Apr. 28, 2016

(54) WATER TREATMENT ASSEMBLY COMPRISING A SOLAR EVAPORATOR

(71) Applicant: AREVA, Courbevoie (FR)

(72) Inventors: Thierry MULLER, SAINT HELENE (FR); Alejandro MOURGUES, LE CREUSOT (FR); Mehdi MOUSSAVI, PARIS (FR)

(21) Appl. No.: 14/896,538

(22) PCT Filed: May 15, 2014
(86) PCT No.: PCT/EP2014/059993

§ 371 Date: Dec. 7, 2015

(30) Foreign Application Priority Data
Jun. 6, 2013 (FR) 13 55235

(51) Int. Cl. B01D 1/00; C02F 1/14

(52) U.S. Cl. CPC B01D 1/0035; C02F 1/14; C02F 2103/08

(57) ABSTRACT

A water treatment assembly is provided. The assembly includes a source generating a flow to be purified; a solar evaporation unit; a transfer duct; a heating device of the transfer duct; and a mechanical ventilation device provided to ensure a forced air circulation in the solar evaporation unit.

The invention generally relates to water treatment and purification.

More specifically, the invention relates to a water treatment assembly, of the type comprising:
a source generating a flow to be purified, said flow to be purified comprising a majority of water, said flow to be purified also comprising at least one compound to be separated from the water;
a solar evaporation unit for said flow to be purified, suitable for evaporating the water from said flow to be purified and condensing the evaporated water into a purified water flow, the unit comprising at least one basin for receiving the flow to be purified having an upward opening and a translucent roof covering the opening;
a transfer duct connecting the source to an evaporation unit, and provided to transfer the flow to be purified from the source to the evaporation unit.

### BACKGROUND

WO 98/33744 describes an assembly of this simple type, but making it possible to purify or desalinate water at a low cost. This assembly is powered by solar energy.

However, this assembly has a limited treatment capacity.

### SUMMARY OF THE INVENTION

In this context, an object of the invention is to provide a higher capacity water treatment assembly.

To that end, the invention relates to a water treatment assembly of the aforementioned type, characterized in that the assembly comprises a heating device for the transfer duct, and a mechanical ventilation device provided to ensure air circulation inside the solar evaporation unit.

The mechanical ventilation device is a device provided to ensure a forced air circulation in the atmosphere of the solar evaporation unit. It is of any appropriate type: fan placed outside the unit, preferably, or fan placed in the evaporation unit, blower, etc.

The heating device of the transfer duct makes it possible to supply the evaporation unit with a flow to be purified at a temperature above the ambient temperature, which contributes to increasing the effectiveness of the solar evaporation. Indeed, the higher the temperature is of the flow to be purified arriving in the evaporation unit, the higher the steam flow rate resulting from the solar heating of the flow will be. The average temperature of the flow to be purified in the basin, at equilibrium, is higher, such that the steam pressure in the atmosphere above the basin is also higher.

The ventilation device makes it possible to limit the temperature stratification and improve the transport coefficients (matter and heat) for the evaporation and condensation of the water. Indeed, without mixing, the air above the basin tends to stratify, a layer of air at a relatively lower temperature being created in contact with the flow to be evaporated, and layers of air at higher temperatures being created near the translucent roof. Because the temperature difference between the air and the liquid is lower at the liquid-gas interface, the evaporation is reduced.

Furthermore, the mixing allows a faster renewal of the gas in contact with the liquid and improves the convection and therefore evaporation.

These two means, i.e., the heating device of the transfer duct and the ventilation device, are compatible with the use in the water treatment assembly of very large receiving basins, which make it possible to obtain a very high treatment capacity.

Furthermore, the joint use of the heating device and the ventilation device makes it possible to achieve a high treatment capacity with an evaporation unit working by greenhouse effect. The unit does not work as an evaporator in which the flow to be purified is brought to a boiling temperature. The flow to be purified in the basin is far from its boiling temperature, such that the quantity of energy necessary to heat the water in the basin is reduced. The evaporation results from the liquid-steam equilibrium on the surface of the basin. The atmosphere above the basin is kept with a partial steam pressure depending in particular on the temperature in the solar evaporation unit. Part of the steam is condensed continuously, which causes the evaporation of part of the flow to be purified located in the receiving basin. The assembly according to embodiments of the invention is therefore technically much simpler than an evaporator in which the flow to be evaporated is boiled, since such an evaporator works under pressure and requires a significant energy contribution, in concentrated form.

Bringing the flow to be purified to a boil indeed requires complex means to concentrate the solar radiation, so as to be able to deliver a large quantity of energy locally to the flow to be purified, which is not compatible with a unit of the type using very large basins in order to obtain a high flow rate.

Embodiments of the invention therefore make it possible to do away with costly devices seeking to boil the flow to be purified, or seeking to increase heat transfers toward the flow to be purified, optically and/or by conduction of the solar energy toward the flow to be purified.

The use of the solar distillation device alone has little impact on the evaporation capacity. Calculations show that under the sunshine conditions of the Niger desert, for example, the output of a simple solar distiller (with no pre-heating or ventilation) is between 1 and 5 l/m²/day. For the flows to be treated, for example 75 m³ per hour, it is difficult to keep the flow at a temperature of 70° C. with solar means having a reasonable cost. Relative to an unheated flow, poured in the basin at a temperature of 30° C., the heating increases the purified water flow rate by approximately 7 to 22 times.

The use of the ventilation device alone also has a moderate effect on the evaporation capacity.

The combined use of the heating device and the ventilation device, however, makes it possible to achieve a significantly better performance, with a purified water flow rate increased by up to 100 times.

The source generating the flow to be purified is for example a seawater pumping station. The flow to be purified is therefore in this case seawater, and the compound to be separated from the water is sodium chloride. However, the unit also makes it possible to separate other elements from the seawater that make that water non-potable, for example, mineral impurities such as sediment or sand and organic impurities such as algae.

Alternatively, the source is a uranium mine. The flow to be purified corresponds to the water pumped in the bottom of the mine, in order to dewater the galleries of the mine. This water contains different compounds, for example traces of uranium, and other metals, such as vanadium, molybdenum, or traces of sulfur.

The source is alternatively a uranium ore treatment unit. Such units generate large flows to be purified, containing traces of uranium and other metals.

In all cases, the flow rate of the flow to be purified is very high, for example above 75 m³ per hour, or a total of several hundreds of thousands of m³ per year. As an example, approximately 650,000 m³ of effluent are poured into the infiltration basins of the COMINAK mines in Niger each year.

The solar evaporation unit is provided to be very simple, with a basin where the flow to be purified runs, covered directly by a translucent roof. The roof does not include optical devices for concentrating the solar radiation. The roof is made from a plastic material or from glass, for example. The solar light crosses through the roof and hits the surface of the basin directly. The basin typically has a large surface area and a small depth in light of the surface area. This facilitates the heating of the flow to be purified. The heating is done inter alia by greenhouse effect, the solar radiation after penetrating the solar unit through the translucent roof remaining trapped, according to a well known principle.

Preferably, the bottom of the basin is covered with a black membrane making it possible to absorb the solar radiation. The energy of the absorbed solar radiation is next returned to the flow to be purified, by radiation, conduction or convection.

The purified water flow is recovered after condensation, by different devices. Gutters are placed below the cold surfaces of the unit, on which the evaporated water can condense. Typically, the roof is V-shaped, with two faces connected to one another along an edge making up the crest of the roof. Gutters are placed along the lower edges of the two faces of the roof. The faces of the translucent roof make up cold surfaces on which the evaporated water condenses preferably and streams to the gutters.

For example, the ventilation device extracts part of the atmosphere situated above the basin, so as to maintain an air circulation in the unit, and more particularly on the surface of the liquid.

The extracted atmosphere passes through a condenser, where the steam from the extracted atmosphere condenses. The condenser is typically of the passive type, and includes a plurality of cold surfaces provided for the condensation of the steam. Such condensers are known and will not be described here in detail.

Alternatively, the ventilation device can include active condensers, for example a refrigerated unit.

The bottom of the receiving basin is typically sloped, so as to cause the flow to be purified to run from one end of the basin to the other end of the basin (241 m long, 206 m wide and 3.7 m deep, typically).

The flow to be purified is received in the basin of at a high point. The bottom of the basin has a gentle slope, such that the flow to be purified is heated gradually as it runs toward the low point of the basin.

The fact that the roof is V-shaped favors the penetration of solar rays inside the evaporation unit.

In order to allow a high treatment capacity, the basins have a large surface area. For example, the surface area of the basins is comprised between 10,000 and 100,000 m², preferably between 20,000 and 80,000 m², and still more preferably between 30,000 and 60,000 m².

Preferably, the ventilation device is arranged to ensure a recirculation rate inside the solar evaporation unit making it possible to obtain a ratio between the mass of the evaporated water and the mass of circulating dry air greater than 0.012.

The recirculation rate must adapt to the expected evaporation performance in the evaporation unit. The dimensioning factor is the ratio between the mass of water evaporated in the solar evaporation unit and the mass of circulating air. This ratio also depends on meteorological conditions: relative humidity, pressure, temperature. This ratio must be greater than 0.012 kg evaporated water/kg circulating dry air.

As indicated above, the ventilation device is provided to limit the temperature stratification effects and improve the transfer coefficients (matter and heat) for the evaporation and condensation of the water. This air circulation allows mixing of the atmosphere and makes it possible to accelerate the evaporation of the water. The recirculation is chosen to obtain a ratio of the mass of evaporated water to the mass of circulating dry air greater than 0.012 (kg evaporated water/kg circulating dry air), preferably comprised between 0.04 and 1.5 (kg evaporated water/kg recirculating dry air), and still more preferably comprised between 0.07 and 0.7 (kg evaporated water/kg recirculating dry air). The recirculation rate here corresponds to the ratio between the volume of air blown each day into the unit and the volume of air situated in the atmosphere of the unit, i.e., in the space situated between the surface of the liquid and the roof. The same volume of air is withdrawn, concomitantly. The pressure inside the unit is always kept close to the atmospheric pressure, so as not to create stress on the translucent roof.

Alternatively, the ventilation device does not remove the air outside the unit, but only ensures movement of air inside the atmosphere of the unit.

Preferably, the heating device comprises at least one mirror provided to concentrate solar radiation on the transfer duct.

Indeed, so as to allow the preheating of a significant flow rate of the flow to be purified, it is necessary to use a heating device making it possible to deliver a high thermal power to the duct. A mirror device is particularly appropriate in this case. This device typically comprises one or more parabolic mirrors. The mirrors are arranged such that the transfer duct occupies a focus of each of the mirrors. The heating device typically comprises a motorized assembly provided to orient and/or move the mirrors based on the travel of the sun in the sky, such that the solar radiation is concentrated by each of the mirrors on the transfer duct during almost the entire day.

Mirror heating devices are considered to be better adapted than Fresnel lens-type devices, which make it possible to obtain a lower power. However, the power must not be concentrated to the point of damaging the transfer duct. Thus, the duct comprises a segment on which the solar radiation is concentrated by the mirror, said segment having a first diameter, the mirror having a second diameter comprised between 5 and 100 times the first diameter. This diameter ratio comprised between 5 and 100 makes it possible to ensure sufficient heating of the flow to be purified, without risk of damaging the wall of the duct. The diameter of the segment refers to the outer diameter of the duct.

Preferably, several mirrors are positioned along the duct.

Preferably, the heating device is suitable for heating a segment of the duct in which the flow to be purified runs along a straight path. Indeed, the flow to be purified is frequently filled with impurities that may become deposited on the inside of the duct. It is therefore preferable not to circulate the flow to be purified along a winding path, for example in serpentines or in devices with bends designed to elongate the journey of the flow to be perfect, so as to increase the heat exchanges. Such paths are not appropriate when the flow to be purified includes elements that may settle. In this context, it is more interesting to use a heating device locally delivering a high thermal power, rather than a heating device delivering a lower power per surface unit, which requires a longer path distance for the flow to be purified.

For these reasons, the duct is arranged so that the flow to be purified has a straight path along the largest part of the duct, preferably over more than 90% of the length of the duct, still more preferably over more than 99% of the length of the duct.

Preferably, the heating device is provided to heat the flow to be purified to a temperature between 40° C. and 80° C. This temperature corresponds to the temperature of the flow to be purified at the end by which the duct emerges in the evaporation unit. The heating device is preferably dimensioned to heat the flow between 60° C. and 70° C.

Heating the flow to be purified beyond 70° C. requires, for the flow rate in question, an excessively high thermal power. Below 40° C., the advantage resulting from preheating the flow to be purified in the duct is low in terms of evaporation capacity, and does not offset the investment necessary to place the heating device.

The flow to be purified in the basin is at a temperature comprised between 50° C. and 90° C., preferably comprised between 60° C. and 80° C. The temperature is lower at the high point of the basin, and higher at the low point of the basin.

The ventilation device comprises a blower member, typically a fan, that blows the atmosphere above the receiving basin, and discharges that atmosphere toward the V-shaped roof of the evaporation unit. As indicated above, a condensation device for the steam located in the suctioned atmosphere is inserted between the basin and the fan, preferably upstream from the fan, and alternatively downstream from the fan.

The assembly preferably comprises a member ensuring a mixed or pulsed circulation of the flow to be purified in the duct. This contributes to limiting the sedimentation of pollutants along the duct. The member making it possible to ensure the mixed or pulsed circulation is a pump adapted to the types of pollutants contained in the flow to be purified (solid state and/or in solution). The flow speeds are chosen so as to limit the sedimentation problems within the ducts. Optionally, a photovoltaic device and/or a solar device with photovoltaic thermal hybrid concentration can be used as electricity source to power the pumping/circulation system and the ventilation device.

In order to make the water treatment assembly as autonomous as possible, the heating device is preferably a hybrid device comprising at least one photovoltaic cell generating electric current supplying electricity to the ventilation device. Thus, the water treatment assembly does not need to be connected to an outside power source. Preferably, the photovoltaic cell(s) also supply electricity to the members ensuring the circulation of the flow to be purified along the duct.

The hybrid device is for example of the type described in patent application FR 2,948,819.

The heating device is typically of the type described in U.S. Pat. No. 6,953,038. These mirrors have the particularity of being able to close, such that the mirrors are protected in case of storms, in particular sandstorms when the water treatment assembly is installed in the desert.

Advantageously, the evaporation unit includes an array of black beams, extending at the surface of the basin.

This black cross-shaped device can be positioned on the surface of the basin, using floats or cables, for example, in order to improve the absorption of the radiation, in particular the visible spectrum. Indeed, this device makes it possible, through cavities, to approach the behavior of a black body, by improving the total absorbance of the incident radiation (in particular for the visible spectrum) toward the water. The shape and geometry of this device are to be optimized depending on the type of sediment and the geometry of the basin.

### BRIEF SUMMARY OF THE INVENTION

Other features and advantages of the invention will emerge from the following detailed description, provided for information and non-limitingly, in reference to the appended figures, in which:

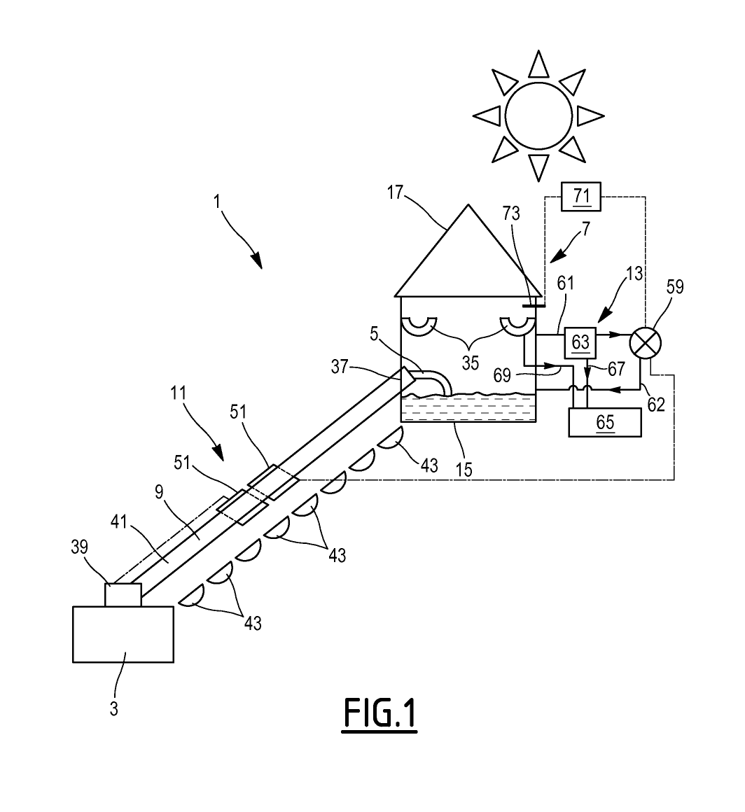

FIG. 1 is a simplified diagrammatic illustration of the treatment unit according to an embodiment of the invention;

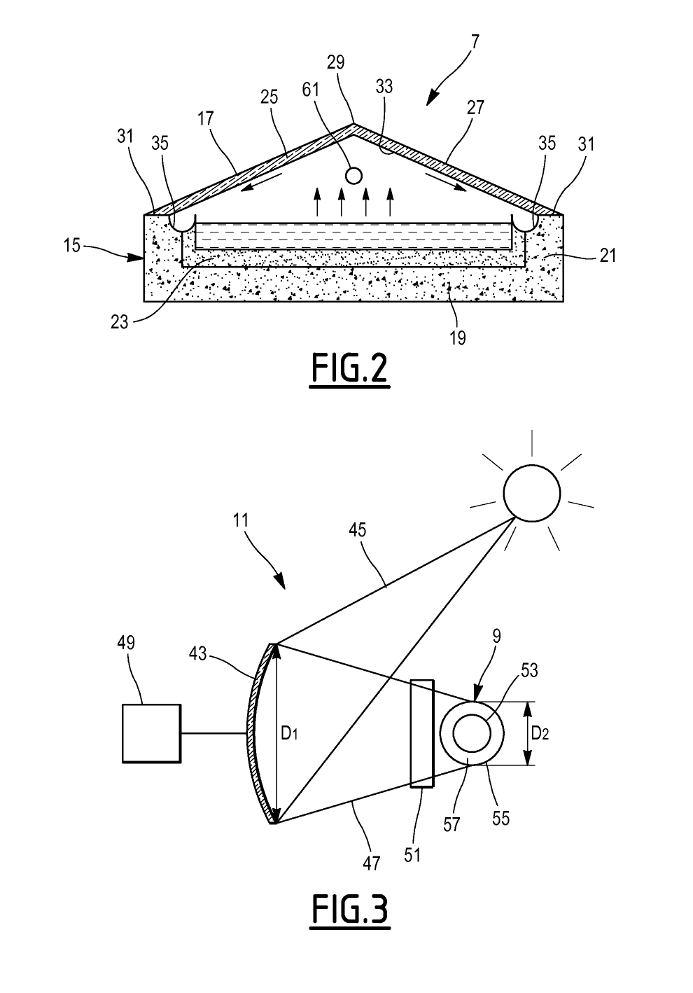

FIG. 2 is a simplified diagrammatic illustration of the solar evaporation unit of FIG. 1;

FIG. 3 is a simplified diagrammatic illustration of the heating device of the transfer duct;

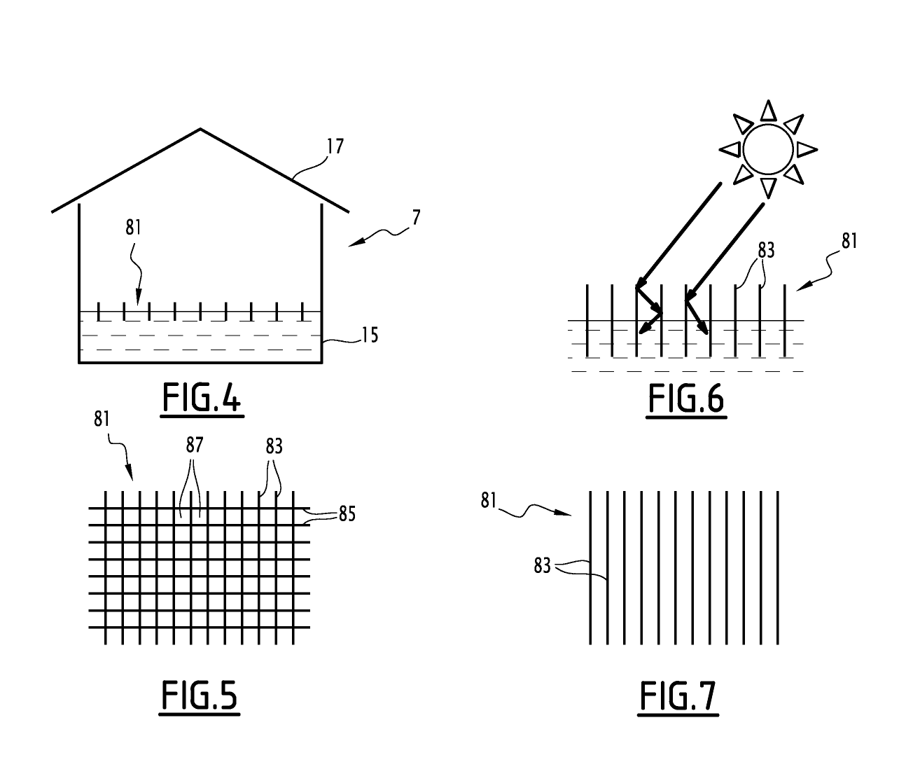

FIG. 4 is a simplified diagrammatic illustration of the array of beams positioned on the surface of the basin;

FIGS. 5 and 7 are top views of two example embodiments of the array of beams; and

FIG. 6 shows the operation of the array of beams of FIGS. 5 and 7.

### DETAILED DESCRIPTION

The water treatment assembly shown in FIG. 1 is designed to be installed in a region where the sunshine is very high, for example in a desert. This assembly comprises:
a source 3 generating a flow to be purified 5;
a solar evaporation unit 7 of said flow to be purified;
a transfer duct 9 connecting the source 3 to the evaporation unit 7;
a heating device 11 of the transfer duct 9; and
a ventilation device 13 provided to improve the transport coefficients.

The source 3 is for example a seawater pumping station, a uranium ore treatment unit, a groundwater pumping unit seeking to dewater the galleries of a uranium mine, etc. The source is alternatively a buffer reservoir supplied by one of the sources mentioned above.

In all cases, the flow to be purified comprises a majority of water, and also at least one compound to be separated from the water. The compound is dissolved in water, or on the contrary assumes the form of a solid in suspension in water. In the case of seawater, the compound be separated primarily corresponds to salt. In the case of effluents coming from a mine or a uranium ore treatment unit, the effluents contain both dissolved species and sludge in suspension in the water.

The water treatment assembly is dimensioned to treat several hundreds of thousands of m³ per year, for example approximately 600,000 m³ per year.

The solar evaporation unit 7 is shown in FIG. 2. This unit comprises one or more receiving basins 15 for the flow to be purified, each covered with a translucent roof 17. Each of the basins is large. Each basin for example has a surface area of 50,000 m², and contains a layer of water approximately 370 cm thick.

The basins are for example made from concrete. They each include an apron 19 and a sidewall 21. Each basin is open toward the top, the opening being defined by the sidewall 21. A black membrane 23 covers the bottom of the basin, i.e., covers the apron 19 of the walls 21. The membrane 23 is made from any suitable material, for example a pitched material.

The roof 17 covers the opening of the basin 15. The roof 17 is made from a translucent material, for example plastic or glass material. It is arranged in a V shape, and has two faces coming together at the crest 29 of the roof 17. The faces are referenced 25 and 27. The lower edges 31 of the two faces 25 and 27 rest on the sidewalls 21 of the basin. The inner surface 33 of the roof 17 serves as a condensation surface for the water that evaporates inside the basin.

The evaporation unit therefore comprises gutters 35 in order to collect the condensed water on the surface 33. The gutters 35 are placed inside the unit, along the lower edges 31 of the roof.

The duct 9 connects the source 3 to the evaporation unit 7, and ensures the transfer of the flow to be purified from the source 3 to the unit 7. The duct 9 is a metal duct, for example made from cast iron. It has as large a diameter as possible. It is substantially straight, and has a limited length, typically less than 200 meters, for example approximately 100 meters. It has a downstream end 37 by which the flow to be purified flows to the inside of the basin 15.

The assembly further includes a circulation pump 39 (FIG. 1), the discharge of which is connected to an upstream end 41 of the duct 9. The aspiration of the pump 39 is connected to the source 3.

The pump 39 is of the appropriate type to ensure a mixed or pulsed circulation of the flow to be purified in the duct 9. The choice of appropriate flow speeds makes it possible to limit sedimentation problems in said ducts. Optionally, a photovoltaic device and/or a solar device with photovoltaic thermal hybrid concentration can be used as electricity source to power the pumping/circulation system and the ventilation device.

The heating device 11 comprises one or more mirrors 43 to concentrate an incident solar beam 45 into a concentrated solar beam 47 oriented toward the duct 9. The duct 9 is preferably situated at the focus of the mirror 43. The mirror 43 is of the cylindro-parabolic type. The heating device 11 typically comprises a kinematic chain 49 suitable for modifying the orientation of the mirror 43 so as to track the travel of the sun, and to be constantly in an appropriate position to concentrate the incident radiation on the duct 9.

Preferably, the heating device 11 includes several mirrors 43 distributed along the duct 9. Each mirror is suitable for heating a separate segment of the duct 9.

The mirrors 43 are of the type described in U.S. Pat. No. 6,953,038. The mirror is subdivided into several sectors movable relative to one another. The sectors can move between a deployed usage position, in which the mirror is suitable for concentrating the incident solar radiation on the duct, and a closed position, in which the concave side of the mirror is completely covered. Thus, in case of sandstorms, the grains of sand cannot damage the reflective surface of the mirror.

Furthermore, in the example shown in FIG. 1, the heating device 11 is a hybrid device, two of the mirrors 43 each being associated with a photovoltaic cell 51 generating an electric current. The photoelectric cells 51 are shown FIG. 3. The mirror 43 and the associated photovoltaic cell 51 are of the type described in patent application FR 2,948,819, and constitute a hybrid solar energy collector. The photovoltaic cell 51 is arranged such that the concentrated beam 47 passes through the photovoltaic cell 51 before lighting the duct 9. In other words, the duct 9 receives the solar energy through the photovoltaic cell 51.

The duct 9, at the photovoltaic cell 51, is a double-walled duct with an intermediate vacuum, comprising an inner tube 53 for circulation of the flow to be purified, and an outer tube 55 surrounding the inner tube 53, an annular isolating space 57 being defined between the inner and outer tubes. At least a partial vacuum is maintained in the annular space 57 so as to limit the heat losses toward the outside.

The electricity produced by the photovoltaic cells 51 powers the circulation pump 39 and the ventilation device 13. The heating device 11 typically comprises batteries (not shown) for storing the electricity.

Each of the mirrors 43 has a diameter D1. The duct 9 has an outer diameter D2. The ratio of D1 to D2 is comprised between 5 and 100. This makes it possible to adjust the thermal power concentration at the duct to an appropriate value, depending on the flow rate of the flow to be purified in the duct 9.

The ventilation device 13 is provided to ensure a circulation of air inside the unit, with a recirculation rate making it possible to obtain a ratio between the mass of evaporated water and a mass of circulating dry air above 0.012 (kg evaporated water/kg recirculating dry air). This air circulation is created in the hemisphere of the unit, i.e., in the volume defined downwardly by the free surface of the flow to be purified contained in the basin 15, and upwardly by the roof 17.

As shown in FIG. 1, the ventilation device 13 includes a fan 59 whereof the suction inlet is connected by a duct 61 to the evaporation unit, and the discharge of which is also connected by a duct 62 to the evaporation unit. The ducts 61 and 62 each communicate with the inner atmosphere of the evaporation unit. A condenser 63 is inserted on the duct 61, between the fan 59 and the evaporation unit 7. The condenser 63 is of the known type, and includes a plurality of cold surfaces on which the steam from the gas suctioned by the fan 59 and coming from the atmosphere of the unit 7, condenses. The condensed purified water is collected in a tank 65, connected to the condenser 63 by a connecting pipe 67. The gutters 35 are also connected to the tank 65 by collecting ducts 60. The ventilation device 13 is controlled by a computer 71 so as to ensure the desired recirculation rate. To that end, the ventilation device is for example equipped with a flow meter (not shown), providing information to the computer, the latter automatically varying the flow rate of the fan based on the value read by the flow meter. Furthermore, the computer 71 is programmed to keep the atmosphere above the receiving basin 15 at a pressure close to the atmospheric pressure. To that end, the ventilation device for example comprises a pressure probe 73 measuring the differential pressure between the atmosphere outside the evaporation unit and the atmosphere inside the solar evaporation unit, and the computer 71 controlling the fan 59 as a function of that pressure difference.

As indicated above, the water treatment assembly can include several basins 15. Each basin is topped by its own specific roof 17. Alternatively, one roof 17 may be shared by several basins.

Likewise, each basin 15 can be supplied by its own specific duct 9. Alternatively, a same duct 9 can serve several basins 15. In any case, each duct 9 is preferably equipped with a heating device specific to it.

Each basin 15 can be equipped with its own specific ventilation device. Alternatively, a same ventilation device 13 can serve several basins.

The operation of the treatment assembly described above will now be outlined.

The flow to be treated is suctioned by the pump 39 and discharged in the duct 9. The flow is pulsed so as to reduce the sedimentation of matter suspended along the duct 9.

The flow to be purified is heated by the heating device 11 while it flows along the duct 9. The mirrors 43 concentrate the solar radiation on the duct 9. They thus heat the wall of the duct 9, the heat thus being transmitted to the flow traveling through the duct 9. The mirrors 43 are constantly oriented toward the sun by the kinetic chain 49, so as to make it possible to heat the flow all throughout the day. The photovoltaic cells 51 produce electric current, and electrically power the fan 59 and the pump 39.

At the downstream end of the duct 9, the flow to be treated 5 is poured into the basin 15. The flow 5 leaving the duct 9 is at a temperature of approximately 70° C. The solar evaporation unit is heated by greenhouse effect. The solar radiation crosses through the translucent roof 17, and is trapped inside the unit. It heats the flow to be purified found in the basin 15. The water of the flow to be purified evaporates, and part of the steam is condensed on the inner surface 33 of the roof. This condensed water streams along two faces 27 and 25 of the roof, and is captured in the gutters 35. It runs from the gutters 35 into the collecting tank 65.

The fan 59 constantly maintains an air circulation inside the evaporation unit, with a flow rate in a predetermined range. To that end, it suctions part of the atmosphere via the suction duct 61. The steam suctioned with the atmosphere is condensed in the condenser 63, and is collected in the tank 65. It discharges the gas in the atmosphere of the evaporation unit.

In one alternative embodiment shown in FIGS. 4 to 7, the evaporation unit includes an array 81 of black beams, extending at the surface of the basin 15.

In the example embodiment of FIG. 5, this array forms a cross-shaped device. It includes a plurality of straight longitudinal beams 83 parallel to one another, and a plurality of straight crossbeams 85 parallel to one another. The longitudinal beams 83 are perpendicular to the crossbeams 85 and secured therewith. The beams 83, 85 together form an array whereof the cells 87 are square. The beams 83, 85 each have a vertically elongated section and are submerged in the flow to be purified approximately over half of their heights.

The device is positioned on the surface of the basin, using floats or cables.

The beams 83, 85 directly absorb part of the incident solar radiation, in particular in the visible spectrum. Furthermore, as illustrated in FIG. 6, another part of the incident solar radiation is reflected toward other beams and is trapped in the cells of the array. This device thus makes it possible, through the cavities, to approach the behavior of a black body, by improving the total absorbance of the incident radiation (in particular for the visible spectrum) toward the water. The shape and geometry of this device are to be optimized depending on the type of sediment and the geometry of the basin.

In the alternative embodiment of FIG. 7, the device 81 only includes longitudinal beams 83, straight and parallel to one another. The cells of the array are therefore longitudinally elongated. The operation is the same as the example embodiment of FIG. 5.

What is claimed is:

1-12. (canceled)

13. A water treatment assembly, comprising:
a source generating a flow to be purified, the flow to be purified comprising a majority of water, the flow to be purified also comprising at least one compound to be separated from the water;
a solar evaporator for the flow to be purified, the solar evaporator configured for evaporating the water from the flow to be purified and condensing the evaporated water into a purified water flow, the solar evaporator comprising at least one basin for receiving the flow to be purified having an upward opening and a translucent roof covering the opening;
a transfer duct connecting the source to the solar evaporator, the transfer duct provided to transfer the flow to be purified from the source to the solar evaporator;
a heater of the transfer duct; and
a mechanical ventilator provided to ensure a forced air circulation in the solar evaporator.

14. The assembly as recited in claim 13 wherein the ventilator is arranged to ensure a recirculation rate inside the solar evaporator making it possible to obtain a ratio between the mass of the evaporated water and the mass of circulating dry air greater than 0.012.

15. The assembly as recited in claim 13 wherein the heater comprises at least one mirror provided to concentrate solar radiation on the transfer duct.

16. The assembly as recited in claim 15 wherein the duct comprises a segment on which the solar radiation is concentrated by the mirror, the segment having a first diameter, the mirror having a second diameter comprised between 5 and 100 times the first diameter.

17. The assembly as recited in claim 13 wherein the heater is configured for heating a segment of the duct in which the flow to be purified runs along a straight path.

18. The assembly as recited in claim 13 wherein the duct is arranged so that the flow to be purified has a straight path along the largest part of the duct.

19. The assembly as recited in claim 13 wherein the heater is provided to heat the flow to be purified to a temperature comprised between 40° C. and 80° C.

20. The assembly as recited in claim 13 wherein further comprising a member ensuring a mixed or pulsed circulation of the flow to be purified in the duct.

21. The assembly as recited in claim 13 wherein the heater is a hybrid device comprising at least one photovoltaic cell generating electric current supplying electricity to the ventilator.

22. The assembly as recited in claim 13 further comprising a member ensuring a circulation of the flow to be purified in the duct, the member being supplied with electricity by the photovoltaic cell.

23. The assembly as recited in claim 13 wherein the solar evaporator operates by greenhouse effect, the flow to be purified in the receiving basin being at a temperature comprised between 50° C. and 90° C.

24. The assembly as recited in claim 13 wherein the solar evaporator includes an array of black beams, extending at the surface of the basin.
